(19) United States
(12) Patent Application Publication
(10) Pub. No.: US 2026/0355808 A1
(43) Pub. Date: Nov. 12, 2026

(54) METHOD FOR CONVERTING MOTION PARAMETERS OF DIE OF THREE-DIMENSIONAL FREE BENDING FORMING APPARATUS

(71) Applicant: NANJING UNIVERSITY OF AERONAUTICS AND ASTRONAUTICS, Nanjing (CN)

(72) Inventors: Cheng CHENG, Nanjing (CN); Xunzhong GUO, Nanjing (CN); Yunjie LU, Nanjing (CN); Chunmei LIU, Nanjing (CN); Yao QIN, Nanjing (CN); Tong DING, Nanjing (CN); Rongji JIANG, Nanjing (CN)

(21) Appl. No.: 19/658,659

(22) Filed: Apr. 26, 2026

(30) Foreign Application Priority Data
May 8, 2025 (CN) 2025105857264

(51) Int. Cl. B21D 9/00; G06F 17/10

(52) U.S. Cl. CPC B21D 9/00; G06F 17/10

(57) ABSTRACT

A method for converting motion parameters of a die of a three-dimensional free bending forming apparatus includes: establishing, based on YBC parameters and an R parameter for tube bending, a tube axis contour including a plurality of forming segments, each of the forming segments including a linear segment and an arc segment; constructing a three-dimensional free bending motion structure corresponding to the tube axis contour; determining, from forming segment data and free bending motion structure data, a bending die eccentric distance U, a movement direction D, and a feeding mechanism advancement distance L for each of the forming segments; and performing spatial pose transformation on U, D, and L to obtain XYZ servo motion parameters of the three-dimensional free bending forming apparatus. The method enables conversion between tube bending data and motion control parameters for the three-dimensional free bending forming apparatus.

### TECHNICAL FIELD

The present disclosure belongs to the field of advanced manufacturing technologies for metal complex members, and particularly relates to a method for converting motion parameters of a die of a three-dimensional free bending forming apparatus.

### BACKGROUND

Bending members with complex spatial configurations are widely used in the fields of aerospace, nuclear energy, new energy vehicles, and the like. In the aerospace field, as a key component for conveying fluids such as fuel, hydraulic oil, and gas, metal tubing generally needs to meet extremely high performance standards. Compared with the traditional forming process, the three-dimensional free bending forming technology has the advantage of enabling the integrated flexible forming of tubes and profiles with complex spatial axes. Due to the lack of a traditional customized die, the forming precision cannot reach that of the traditional forming technology, and it is difficult to accurately form the axial shape of a formed member at one time. Therefore, the forming precision error analysis needs to be performed on the formed member by using a three-dimensional scanner. The results output by the three-dimensional scanner refer to the standard data formats YBC and R for tube bending, and a conversion method is required to quantitatively convert the output results of the scanner into motion parameters that can be identified by the three-dimensional free bending forming apparatus to improve the precision correction efficiency of the member contour.

### SUMMARY

Aiming at the defects in the background art, the present disclosure provides a method for converting motion parameters of a die of a three-dimensional free bending forming apparatus. Rapid conversion of data formats is achieved in terms of three-dimensional free bending and precision compensation of a tube bending member.

The present disclosure adopts the following technical solutions:

Provided is a method for converting motion parameters of a die of a three-dimensional free bending forming apparatus, which includes the following steps:
Step I, namely establishing the tube axis contour based on the YBC parameters and the R parameter for tube bending, includes sequentially dividing a tube bending member into n forming segments based on geometric parameters composed of the YBC parameters and the R parameter for tube bending, each of the forming segments being denoted by i, where i=1, 2, 3, . . . , n, and each of the forming segments including the linear segment and the arc segment, and reconstructing spatial poses of the forming segments in a three-dimensional space to form the tube axis contour.
Step II, namely constructing the three-dimensional free bending motion structure corresponding to the tube axis contour, includes converting lengths of the linear segments and the arc segments of the tube axis contour into the feeding mechanism of the three-dimensional free bending motion structure and converting radii and spatial directions of the arc segments of the tube axis contour into the bending die mechanism of the three-dimensional free bending motion structure.
Step III, namely determining the bending die eccentric distance U, the movement direction D, and the feeding mechanism advancement distance L for each of the forming segments, comprises converting the forming segment data based on free bending motion structure data according to the following steps.
Step IV includes performing spatial pose transformation on the bending die eccentric distance U, the movement direction D, and the feeding mechanism advancement distance L to obtain XYZ servo motion parameters of the three-dimensional free bending forming apparatus. A free bending process of a forming segment, including a linear segment and an arc segment, consists of a transition segment and a stabilization segment. During conversion, one row of forming segment data is converted into four rows of XYZ servo motion data consisting of a linear transition segment, a linear stabilization segment, an arc transition segment, and an arc stabilization segment.

Establishing the tube axis contour of the plurality of forming segments (each forming segment consisting of the linear segment and the arc segment) on the basis of the YBC parameters and the R parameter for the tube bending refers to: sequentially dividing a tube bending member into n forming segments on the basis of geometric parameters composed of the YBC and the R for the tube bending, where each forming segment is denoted as i (each forming segment i consisting of the linear segment and the arc segment), and the forming segments are numbered in sequence, i.e., i=1, 2, 3, . . . , n; and reconstructing spatial poses of the respective forming segments in a three-dimensional space to form the tube axis contour.

Equivalently constructing the tube axis contour into the free bending motion structure refers to: equivalently converting lengths of the linear segments and the arc segments of a tube axis into a feeding mechanism of the three-dimensional free bending motion structure, and equivalently converting a radius and a spatial direction of the arc segments of the tube axis into a bending die mechanism of the three-dimensional free bending motion structure.

Sequentially resolving the forming segment data on the basis of free bending motion structure data to obtain conversion correspondences among the bending die eccentric distance U, the movement direction D, and the feeding mechanism advancement distance L includes:
Step 3a includes converting a radius value of an i-th forming segment in the forming segment data into the bending die eccentric distance U based on a U-R relationship data formula of the three-dimensional free bending forming apparatus:

$${U}_{i} = 0$$

$${U}_{i}^{′} = {R}_{i} - \sqrt{{R}_{i}^{2} - {A}^{2}}$$

In this step, as shown in FIG. 4, Ui represents a bending die eccentric distance of a linear segment in the i-th forming segment, and when a straight line is formed, the bending die is in an initial state without deflection; Ri and Ui′ represent the radius of an arc segment in the i-th forming segment and the corresponding bending die eccentric distance; and A represents the distance between the center of the bending die of the three-dimensional free bending forming apparatus and the center of the front end of a guiding mechanism in the horizontal direction.
Step 3b includes converting a length of the linear segment of the i-th forming segment in the forming segment data into the feeding mechanism advancement distance L of the three-dimensional free bending forming apparatus:

Lᵢ=Yᵢ

In this step, Yi and Li represent a linear feeding length of the linear segment in the i-th forming segment and a corresponding feeding mechanism advancement distance of the three-dimensional free bending forming apparatus.
Step 3c includes converting a direction value of the arc segment of the i-th forming segment in the forming segment data into the movement direction D of the bending die in the three-dimensional free bending forming apparatus:

$${D}_{i} = 0$$

$${D}_{i}^{′} = - {\sum }_{1}^{i} {B}_{i}$$

In this step, Di represents a spatial rotation direction angle of the bending die of the linear segment in the i-th forming segment, and the bending die of the linear segment does not need to rotate; Bi and Di′ represent a spatial rotation angle of the arc segment in the i-th forming segment and a corresponding spatial rotation direction angle of the bending die.
Step 3d includes converting an angle value of the arc segment of the i-th forming segment in the forming segment data into the feeding mechanism advancement distance L and the bending die eccentric distance U in the three-dimensional free bending forming apparatus:

$${L}_{i}^{′} = \frac{ω {R}_{i} {C}_{i}}{180}$$

where Rᵢ, Cᵢ, and Lᵢ′ represent the radius of the arc segment in the i-th forming segment, an angle of the arc segment, and the feeding mechanism advancement distance of the three-dimensional free bending forming apparatus.

For a first forming segment, the XYZ servo motion parameters of the three-dimensional free bending forming apparatus are determined according to the following conversion relationship:

$${X}_{1} = {X}_{1}^{′} = 0$$

$${Y}_{1} = {Y}_{1}^{′} = 0$$

$${Z}_{1} = 0$$

$${Z}_{1}^{′} = {L}_{1}$$

$${X}_{1}^{″} = {X}_{1}^{′′′} = {U}_{1}^{′} cos {D}_{1}^{′}$$

$${Y}_{1}^{″} = {Y}_{1}^{′′′} = {U}_{1}^{′} sin {D}_{1}^{′}$$

$${Z}_{1}^{″} = {L}_{1} + \frac{{U}_{1}^{′}}{{V}_{m}} {V}_{p}$$

$${Z}_{1}^{′′′} = {L}_{1} + {L}_{1}^{′}$$

where X₁, X₁′, Y₁, Y₁′, Z₁, and Z₁′ represent absolute positioning positions of XYZ-axis servo motors of the three-dimensional free bending forming apparatus corresponding to a transition segment and a stabilization segment of a linear segment in the first forming segment, respectively, and X₁″, X₁′″, Y₁″, Y₁′″, Z₁″, and Z₁′″ represent absolute positioning positions of the XYZ-axis servo motors of the three-dimensional free bending forming apparatus corresponding to a transition segment and a stabilization segment of an arc segment in the first forming segment, respectively.

In the step of performing the spatial pose transformation on the three-dimensional free bending motion parameters UDL to acquire the XYZ servo motion parameters of the three-dimensional free bending apparatus, for an i-th forming segment (i>1), a conversion relationship is as follows:

$${X}_{i} = {X}_{i}^{′} = 0$$

$${Y}_{i} = {Y}_{i}^{′} = 0$$

$${Z}_{i} = {{\sum }_{1}}^{i} {L}_{i} + {\sum }_{1}^{i - 1} {L}_{i}^{′} - \frac{{U}_{i - 1}^{′}}{{V}_{m}} {V}_{p}$$

$${Z}_{i}^{′} = {{\sum }_{1}}^{i} {L}_{i} + {\sum }_{1}^{i - 1} {L}_{i}^{′}$$

$${X}_{i}^{″} = {X}_{i}^{′′′} = {U}_{i}^{′} cos {D}_{i}^{′}$$

$${Y}_{i}^{″} = {Y}_{i}^{′′′} = {U}_{i}^{′} sin {D}_{i}^{′}$$

$${Z}_{i}^{″} = {\sum }_{1}^{i} ( {L}_{i} + {L}_{i}^{′} ) - \frac{{U}_{i}^{′}}{{V}_{m}} {V}_{p}$$

$${Z}_{i}^{′′′} = {\sum }_{1}^{i} ( {L}_{i} + {L}_{i}^{′} )$$

where Vₘ and Vₚ represent a bending die movement speed and a feeding mechanism advancement speed of the three-dimensional free bending forming apparatus; Xᵢ, Xᵢ′, Yᵢ, Yᵢ′, Zᵢ, and Zᵢ′ represent absolute positioning positions of XYZ-axis servo motors of the three-dimensional free bending forming apparatus corresponding to a transition segment and a stabilization segment of a linear segment in the i-th forming segment, respectively; Xᵢ″, Xᵢ′″, Yᵢ″, Yᵢ′″, Zᵢ″, and Zᵢ′″ represent absolute positioning positions of the XYZ-axis servo motors of the three-dimensional free bending forming apparatus corresponding to a transition segment and a stabilization segment of an arc segment in the i-th forming segment, respectively.

The present disclosure has the following beneficial effects:

Firstly, the calculation and conversion mode of the present disclosure is simple and feasible, and the present disclosure can directly interface with the processing parameters of the CNC bending device and the detection and feedback parameters of the three-dimensional scanning device, providing a theoretical numerical basis for optimizing the processing and forming contour accuracy of the three-dimensional free bending forming apparatus.

Secondly, the present disclosure enables undifferentiated transformation between traditional CNC bending processing data and three-dimensional free bending processing data, which expands the flexibility of processing technique selection for tubes, and solves the problem of how to determine a movement direction, an offset distance, and a rotation angle of a bending die on the basis of a tube axis contour.

### BRIEF DESCRIPTION OF THE DRAWINGS

FIG. 1 is a flowchart of the present disclosure;

FIG. 2 is a schematic diagram illustrating the conversion between YBCR parameters of a bent member and a tube axis contour according to the present disclosure;

FIG. 3 is a schematic diagram illustrating the structure of a three-dimensional free bending forming apparatus mechanism according to the present disclosure; and

FIG. 4 is a schematic diagram illustrating bending forming of the three-dimensional free bending forming apparatus according to the present disclosure.

### DETAILED DESCRIPTION

To make the objectives, technical solutions, and advantages of the present disclosure clearer, the following describes the present disclosure in detail with reference to the accompanying drawings and specific embodiments.

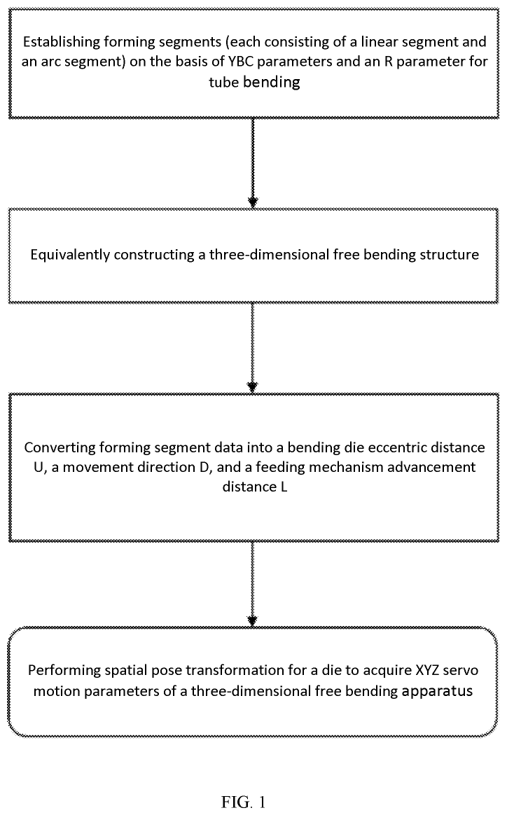

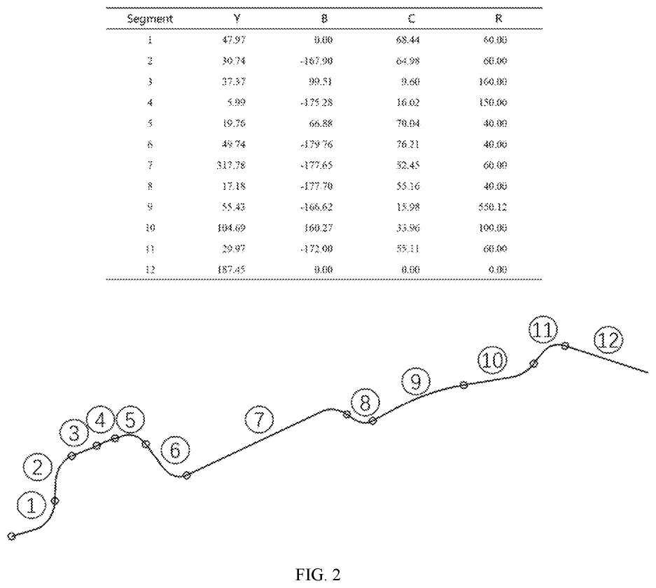

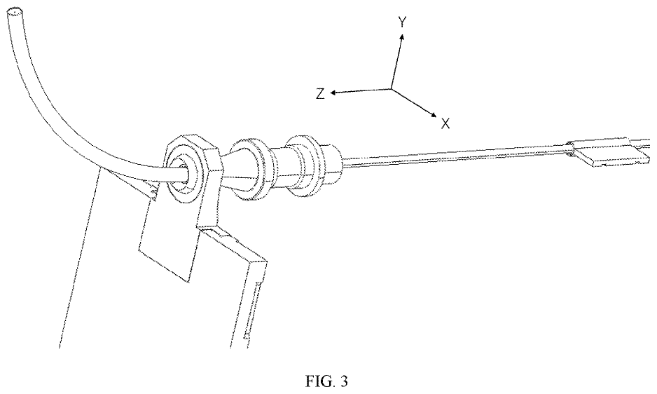

FIG. 1 shows a flowchart of a method for converting motion parameters of a die of a three-dimensional free bending forming apparatus, which mainly includes the following steps:
(1) Before bending forming, a tube bending member is sequentially divided into n forming segments (each consisting of a linear segment and an arc segment) on the basis of geometric parameters composed of YBC and R for tube bending, and the forming segments are sequentially numbered as i=1, 2, 3 . . . n; and the spatial poses of the respective forming segments are reconstructed in a three-dimensional space to form a tube axis contour, and the division results are shown in FIG. 2.
(2) The structure of the three-dimensional free bending forming apparatus mechanism is shown in FIG. 3. The lengths of the linear segments and the arc segments in the tube axis contour are equivalently converted into a feeding mechanism of the three-dimensional free bending motion structure, and the radii and the spatial directions of the arc segments in the tube axis are equivalently converted into a bending die mechanism of the three-dimensional free bending motion structure.
(3) The forming segment data is sequentially resolved into a bending die eccentric distance U, a movement direction D, and a feeding mechanism advancement distance L.
(3a) For the conversion of a radius value of an i-th forming segment (a linear segment and an arc segment) in the forming segment data, an eccentric distance value required for forming the current radius is obtained by calculation via a fitting formula of the eccentric distance U and the bending radius R of the bending die of the three-dimensional free bending forming apparatus;

$${U}_{i} = 0$$

$${U}_{i}^{′} = {R}_{i} - \sqrt{{R}_{i}^{2} - {A}^{2}}$$

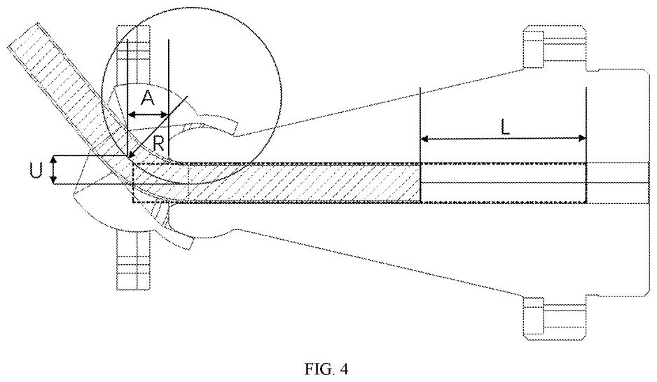

in this step, as shown in FIG. 4, Uᵢ represents a bending die eccentric distance of the linear segment in the i-th forming segment, and when a straight line is formed, the bending die is in an initial state without deflection; Rᵢ and Uᵢ′ represent the radius of the arc segment in the i-th forming segment and the corresponding bending die eccentric distance; A represents the distance between the center of the bending die of the three-dimensional free bending forming apparatus and the center of the front end of a guiding mechanism in the horizontal direction.
(3b) For the conversion of the length of the linear segment in the i-th forming segment (the linear segment and the arc segment) of the forming segment data, according to a forming principle of the three-dimensional free bending forming apparatus, the length Y of the linear segment is equivalently converted into the feeding mechanism advancement distance L.

Lᵢ=Yᵢ
(3c) For the conversion of a direction value of the arc segment in the i-th forming segment (the linear segment and the arc segment) of the forming segment data, according to the forming principle of the three-dimensional free bending forming apparatus, a spatial direction angle of the arc segment is an angle increment value converted into a spatial absolute angle D of the bending die in the three-dimensional free bending forming apparatus based on a deflection angle relative to an arc surface of the previous forming segment;

$${D}_{i} = 0$$

$${D}_{i}^{′} = - {\sum }_{1}^{i} {B}_{i}$$

in this step, Dᵢ represents a spatial rotation direction angle of the bending die of the linear segment in the i-th forming segment, and the bending die of the linear segment does not need to rotate; Bᵢ and Dᵢ′ represent a spatial rotation angle of the arc segment in the i-th forming segment and a corresponding spatial rotation direction angle of the bending die.
(3d) For the conversion of an angle value of the arc segment in the i-th forming segment (the linear segment and the arc segment) of the forming segment data, according to the forming principle of the three-dimensional free bending forming apparatus, the feeding mechanism advancement distance L determines the arc length value of the arc segment, and the bending die eccentric distance U determines the radius value of the arc segment;

$${L}_{i}^{′} = \frac{ω {R}_{i} {C}_{i}}{180}$$

where Rᵢ, Cᵢ, and Lᵢ′ represent the radius of the arc segment in the i-th forming segment, an angle of the arc segment, and the feeding mechanism advancement distance of the three-dimensional free bending forming apparatus.
(4) Spatial pose transformation is performed on the three-dimensional free bending motion parameters UDL to acquire XYZ servo motion parameters of the three-dimensional free bending apparatus. A free bending process of a forming segment (a linear segment and an arc segment) consists of a transition segment and a stabilization segment. During conversion, one row of forming segment data is converted into four rows of XYZ servo motion data consisting of a linear transition segment, a linear stabilization segment, an arc transition segment, and an arc stabilization segment.

The conversion relationship for the first forming segment is as follows:

$${X}_{1} = {X}_{1}^{′} = 0$$

$${Y}_{1} = {Y}_{1}^{′} = 0$$

$${Z}_{1} = 0$$

$${Z}_{1}^{′} = {L}_{1}$$

$${X}_{1}^{″} = {X}_{1}^{′′′} = {U}_{1}^{′} cos {D}_{1}^{′}$$

$${Y}_{1}^{″} = {Y}_{1}^{′′′} = {U}_{1}^{′} sin {D}_{1}^{′}$$

$${Z}_{1}^{″} = {L}_{1} + \frac{{U}_{1}^{′}}{{V}_{m}} {V}_{p}$$

$${Z}_{1}^{′′′} = {L}_{1} + {L}_{1}^{′}$$

where X₁, X₁′, Y₁, Y₁′, Z₁, and Z₁′ represent absolute positioning positions of XYZ-axis servo motors of the three-dimensional free bending forming apparatus corresponding to a transition segment and a stabilization segment of a linear segment in the first forming segment, respectively; X₁″, X₁′″, Y₁″, Y₁′″, Z₁″, and Z₁′″ represent absolute positioning positions of the XYZ-axis servo motors of the three-dimensional free bending forming apparatus corresponding to a transition segment and a stabilization segment of an arc segment in the first forming segment, respectively.

The conversion relationship for the i-th forming segment (i>1) is as follows:

$${X}_{i} = {X}_{i}^{′} = 0$$

$${Y}_{i} = {Y}_{i}^{′} = 0$$

$${Z}_{i} = {{\sum }_{1}}^{i} {L}_{i} + {\sum }_{1}^{i - 1} {L}_{i}^{′} - \frac{{U}_{i - 1}^{′}}{{V}_{m}} {V}_{p}$$

$${Z}_{i}^{′} = {{\sum }_{1}}^{i} {L}_{i} + {\sum }_{1}^{i - 1} {L}_{i}^{′}$$

$${X}_{i}^{″} = {X}_{i}^{′′′} = {U}_{i}^{′} cos {D}_{i}^{′}$$

$${Y}_{i}^{″} = {Y}_{i}^{′′′} = {U}_{i}^{′} sin {D}_{i}^{′}$$

$${Z}_{i}^{″} = {\sum }_{1}^{i} ( {L}_{i} + {L}_{i}^{′} ) - \frac{{U}_{i}^{′}}{{V}_{m}} {V}_{p}$$

$${Z}_{i}^{′′′} = {\sum }_{1}^{i} ( {L}_{i} + {L}_{i}^{′} )$$

where Vₘ and Vₚ represent a bending die movement speed and a feeding mechanism advancement speed of the three-dimensional free bending forming apparatus; Xᵢ, Xᵢ′, Yᵢ, Yᵢ′, Zᵢ, and Zᵢ′ represent absolute positioning positions of XYZ-axis servo motors of the three-dimensional free bending forming apparatus corresponding to a transition segment and a stabilization segment of a linear segment in the i-th forming segment, respectively; Xᵢ″, Xᵢ′″, Yᵢ″, Yᵢ′″, Zᵢ″, and Zᵢ′″ represent absolute positioning positions of the XYZ-axis servo motors of the three-dimensional free bending forming apparatus corresponding to a transition segment and a stabilization segment of an arc segment in the i-th forming segment, respectively.

It should be understood that a person of ordinary skill in the art may make improvements or modifications according to the foregoing description without departing from the spirit and scope of the present application. If these modifications and variations of the present application fall within the scope of the present application and the same technology as the present application, the present application is also intended to cover these modifications and variations.

1. A method for converting motion parameters of a die of a three-dimensional free bending forming apparatus, comprising the following steps:
step I: establishing, based on YBC parameters and an R parameter for tube bending, a tube axis contour including a plurality of forming segments, each of the forming segments including a linear segment and an arc segment;
step II: constructing a three-dimensional free bending motion structure corresponding to the tube axis contour by converting lengths of the linear segments and the arc segments of the tube axis contour into a feeding mechanism of the three-dimensional free bending motion structure and converting radii and spatial directions of the arc segments of the tube axis contour into a bending die mechanism of the three-dimensional free bending motion structure;
step III: determining, from forming segment data and free bending motion structure data, a bending die eccentric distance U, a movement direction D, and a feeding mechanism advancement distance L for each of the forming segments; and
step IV: performing spatial pose transformation on the bending die eccentric distance U, the movement direction D, and the feeding mechanism advancement distance L to obtain XYZ servo motion parameters of the three-dimensional free bending forming apparatus.

2. The method according to claim 1, wherein step I comprises:
sequentially dividing a tube bending member into n forming segments based on geometric parameters composed of the YBC parameters and the R parameter for tube bending, each of the forming segments being denoted by i, where i=1, 2, 3, . . . , n, and each of the forming segments including the linear segment and the arc segment; and
reconstructing spatial poses of the forming segments in a three-dimensional space to form the tube axis contour.

3. The method according to claim 1, wherein step II comprises:
converting lengths of the linear segments and the arc segments of the tube axis contour into the feeding mechanism of the three-dimensional free bending motion structure; and
converting radii and spatial directions of the arc segments of the tube axis contour into the bending die mechanism of the three-dimensional free bending motion structure.

4. The method according to claim 1, wherein step III comprises:
step 3a: converting a radius value of an i-th forming segment in the forming segment data into the bending die eccentric distance U based on a U-R relationship data formula of the three-dimensional free bending forming apparatus,
$${U}_{i} = 0$$
$${U}_{i}^{′} = {R}_{i} - \sqrt{{R}_{i}^{2} - {A}^{2}}$$
wherein Ui represents a bending die eccentric distance of a linear segment in the i-th forming segment, Ri and Ui′ represent a radius of an arc segment in the i-th forming segment and a corresponding bending die eccentric distance, and A represents a distance between a center of a bending die of the three-dimensional free bending forming apparatus and a center of a front end of a guiding mechanism in a horizontal direction;
step 3b: converting a length of the linear segment of the i-th forming segment in the forming segment data into the feeding mechanism advancement distance L of the three-dimensional free bending forming apparatus,
Lᵢ=Yᵢ
wherein Yi and Li represent a linear feeding length of the linear segment in the i-th forming segment and a corresponding feeding mechanism advancement distance of the three-dimensional free bending forming apparatus;
step 3c: converting a direction value of the arc segment of the i-th forming segment in the forming segment data into the movement direction D of the bending die in the three-dimensional free bending forming apparatus,
$${D}_{i} = 0$$
$${D}_{i}^{′} = - {\sum }_{1}^{i} {B}_{i}$$
wherein Di represents a spatial rotation direction angle of the bending die of the linear segment in the i-th forming segment, and Bi and Di′ represent a spatial rotation angle of the arc segment in the i-th forming segment and a corresponding spatial rotation direction angle of the bending die; and
step 3d: converting an angle value of the arc segment of the i-th forming segment in the forming segment data into the feeding mechanism advancement distance L and the bending die eccentric distance U in the three-dimensional free bending forming apparatus,
$${L}_{i}^{′} = \frac{ω {R}_{i} {C}_{i}}{180}$$
wherein Ri, Ci, and Li′ represent the radius of the arc segment in the i-th forming segment, an angle of the arc segment, and the feeding mechanism advancement distance of the three-dimensional free bending forming apparatus.

5. The method according to claim 1, wherein step IV, for a first forming segment, comprises determining the XYZ servo motion parameters of the three-dimensional free bending forming apparatus according to the following conversion relationship:
$${X}_{1} = {X}_{1}^{′} = 0$$
$${Y}_{1} = {Y}_{1}^{′} = 0$$
$${Z}_{1} = 0$$
$${Z}_{1}^{′} = {L}_{1}$$
$${X}_{1}^{″} = {X}_{1}^{′′′} = {U}_{1}^{′} cos {D}_{1}^{′}$$
$${Y}_{1}^{″} = {Y}_{1}^{′′′} = {U}_{1}^{′} sin {D}_{1}^{′}$$
$${Z}_{1}^{″} = {L}_{1} + \frac{{U}_{1}^{′}}{{V}_{m}} {V}_{p}$$
$${Z}_{1}^{′′′} = {L}_{1} + {L}_{1}^{′}$$
wherein X₁, X₁′, Y₁, Y₁′, Z₁, and Z₁′ represent absolute positioning positions of XYZ-axis servo motors of the three-dimensional free bending forming apparatus corresponding to a transition segment and a stabilization segment of a linear segment in the first forming segment, respectively, and X₁″, X₁′″, Y₁″, Y₁′″, Z₁″, and Z₁′″ represent absolute positioning positions of the XYZ-axis servo motors of the three-dimensional free bending forming apparatus corresponding to a transition segment and a stabilization segment of an arc segment in the first forming segment, respectively.

6. The method according to claim 1, wherein step IV, for an i-th forming segment where i>1, comprises determining the XYZ servo motion parameters of the three-dimensional free bending forming apparatus according to the following conversion relationship:
$${X}_{i} = {X}_{i}^{′} = 0$$
$${Y}_{i} = {Y}_{i}^{′} = 0$$
$${Z}_{i} = {{\sum }_{1}}^{i} {L}_{i} + {\sum }_{1}^{i - 1} {L}_{i}^{′} - \frac{{U}_{i - 1}^{′}}{{V}_{m}} {V}_{p}$$
$${Z}_{i}^{′} = {{\sum }_{1}}^{i} {L}_{i} + {\sum }_{1}^{i - 1} {L}_{i}^{′}$$
$${X}_{i}^{″} = {X}_{i}^{′′′} = {U}_{i}^{′} cos {D}_{i}^{′}$$
$${Y}_{i}^{″} = {Y}_{i}^{′′′} = {U}_{i}^{′} sin {D}_{i}^{′}$$
$${Z}_{i}^{″} = {\sum }_{1}^{i} ( {L}_{i} + {L}_{i}^{′} ) - \frac{{U}_{i}^{′}}{{V}_{m}} {V}_{p}$$
$${Z}_{i}^{′′′} = {\sum }_{1}^{i} ( {L}_{i} + {L}_{i}^{′} )$$
wherein Vₘ and Vₚ represent a bending die movement speed and a feeding mechanism advancement speed of the three-dimensional free bending forming apparatus, Xᵢ, Xᵢ′, Yᵢ, Yᵢ′, Zᵢ, and Zᵢ′ represent absolute positioning positions of XYZ-axis servo motors of the three-dimensional free bending forming apparatus corresponding to a transition segment and a stabilization segment of a linear segment in the i-th forming segment, respectively, and Xᵢ″, Xᵢ′″, Yᵢ″, Yᵢ′″, Zᵢ″, and Zᵢ′″ represent absolute positioning positions of the XYZ-axis servo motors of the three-dimensional free bending forming apparatus corresponding to a transition segment and a stabilization segment of an arc segment in the i-th forming segment, respectively.
